(19) United States
(12) Patent Application Publication
(10) Pub. No.: US 2005/0099658 A1
(43) Pub. Date: May 12, 2005

(54) Scanner

(75) Inventor: Sheng-Kao Chen, Hsinchu (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/986,690

(22) Filed: Nov. 12, 2004

(30) Foreign Application Priority Data
Nov. 12, 2003 (TW) TW92220016

(51) Int. Cl. H04N 1/04

(52) U.S. Cl. 358/474

(57) ABSTRACT

A scanner includes a platen, a scanning device and a supporting structure. The scanning device is movably disposed under the platen. The supporting structure is disposed in the scanning device comprising a contacting member and a resilient member connected to the contacting member. When the platen abuts the contacting member, the resilient member deforms to move the scanning device contacting the contacting member, such that a predetermined distance is maintained between the platen and the scanning device.

### BACKGROUND

The inventions relates to a scanner and in particular to a scanner with contact image sensor (CIS).

FIG. 1a shows a conventional contact image sensor (CIS) scanner, which includes an upper frame 11, a lower frame 12, a platen 13, a scan head 14, a track 15 and a driving mechanism 16. The upper frame 11 has an opening 111 therein in which the platen 13 is disposed. The scan head 14 is disposed between the upper frame 11 and the lower frame 12. A contact image sensor (not shown) is recessed in the scan head 14. The contact image sensor scans the object placed on the platen 13. The track 15 is disposed in the lower frame 12. The scan head 14 has a connecting portion 141 connected to the track 15. The driving mechanism 16 moves the scan head 14 along the track 15, completing the scan of the object.

FIG. 1b shows the structure of the scanner shown in FIG. 1a, and FIG. 1c is cross section along IC-IC′ line of FIG. 1b. In FIGS. 1b and 1c, the connecting portion 141 is formed at the bottom of the scan head 14. Several rollers 142 are installed at the top of the scan head 14 to contact the platen 13. Meanwhile, the scan head 14 is connected to the driving mechanism 16 by a belt 161, moving the scan head 14 along the track 15.

It may be difficult to maintain a predetermined distance between the object and the contact image sensor. Any fluctuation in mechanical dimension or change in temperature can cause deformation in material and render mass production difficult.

### SUMMARY

Therefore, an object of the present invention is to disclose a scanner that solves the above mentioned problem.

The scanner comprises a platen, a scanning device and a supporting structure. An object is placed on the platen. The scanning device is movably disposed under the platen. The supporting structure is disposed in the scanning device and comprises a contacting member and a resilient member connected thereto. When the platen abuts the contacting member, the resilient member deforms to move the scanning device contacting the contacting member, such that a predetermined distance is maintained between the platen and the scanning device.

The scanning device and the resilient member are integrally formed.

The resilient member comprises a first portion, a second portion and a third portion. The first portion supports the contacting member, the second portion is disposed on the scanning device, and the third portion supports the scanning device. When the platen abuts the contacting member to move the first portion, the resilient member rotates via the second portion, and the third portion moves toward the scanning device until the scanning device contacts the contacting member. Thus, the predetermined distance is maintained between the platen and the scanning device.

The scanning device comprises a sensor and a carriage receiving the sensor.

Further, the resilient member comprises a first portion supporting the contacting member, a second portion disposed on the carriage and a third portion supporting the sensor. When the platen abuts the contacting member to move the first portion, the resilient member rotates via the second portion, and then the third portion moves toward the sensor until the sensor contacts the contacting member, whereby the predetermined distance is maintained between the platen and the sensor.

The carriage and the resilient member are integrally formed.

A driving mechanism conveys the scanning device.

### DESCRIPTION OF THE DRAWINGS

FIG. 1a is a schematic diagram of a conventional scanner;

FIG. 1b is an enlarged view of the scanner according to FIG. 1a;

FIG. 1c is a cross section along IC-IC′ line of FIG. 1b;

FIG. 2a is a cross section of the scanner of the present invention before a platen is attached thereon; and

FIG. 2b is a cross section of the scanner of the present invention after the platen is attached thereon.

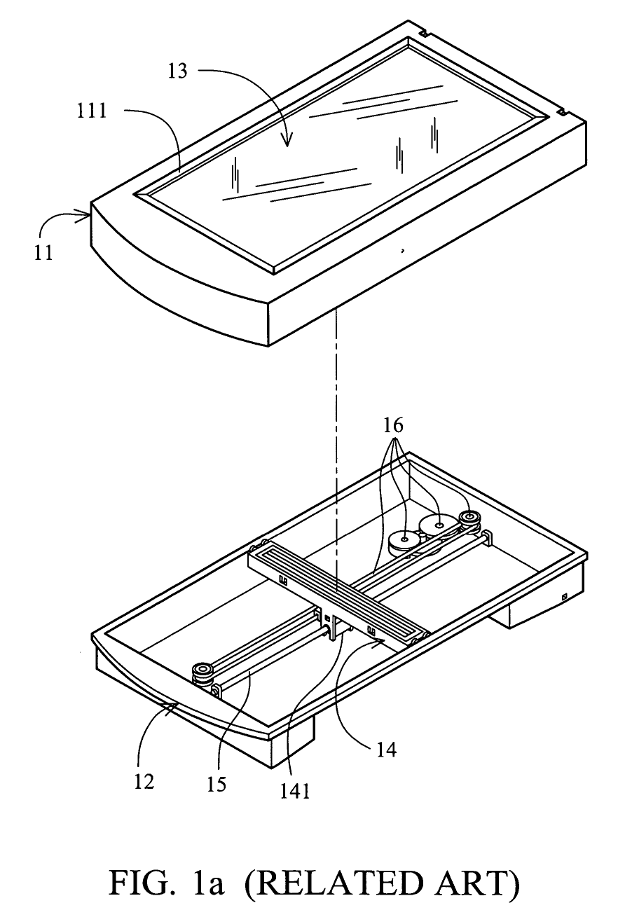

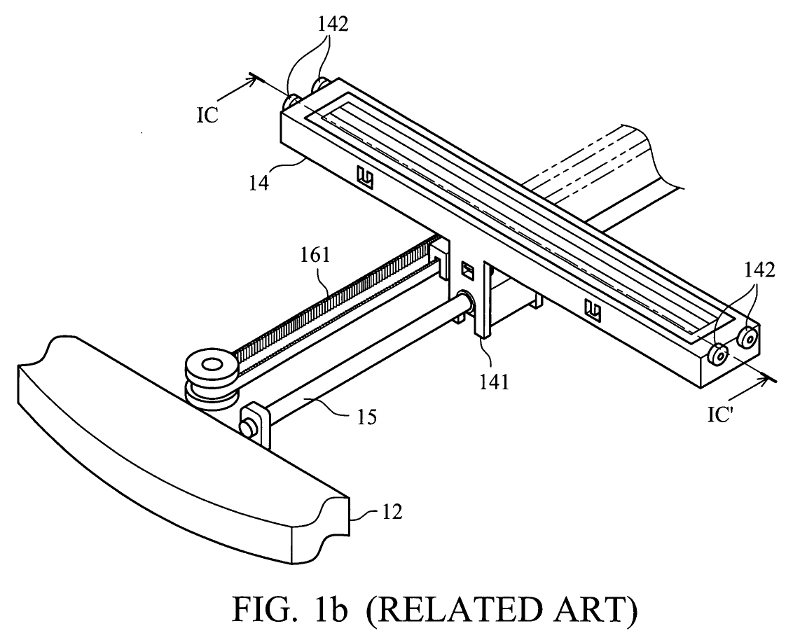

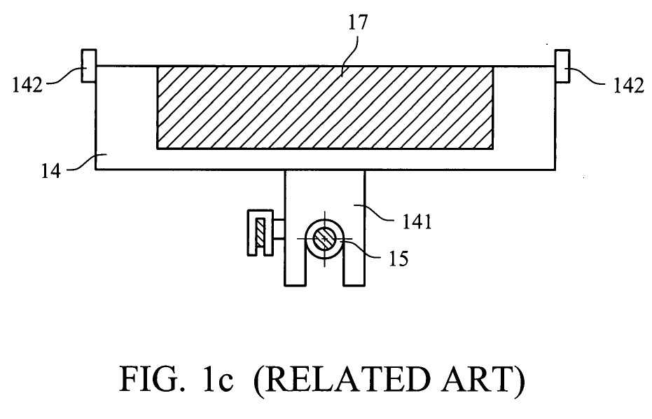

### DETAILED DESCRIPTION

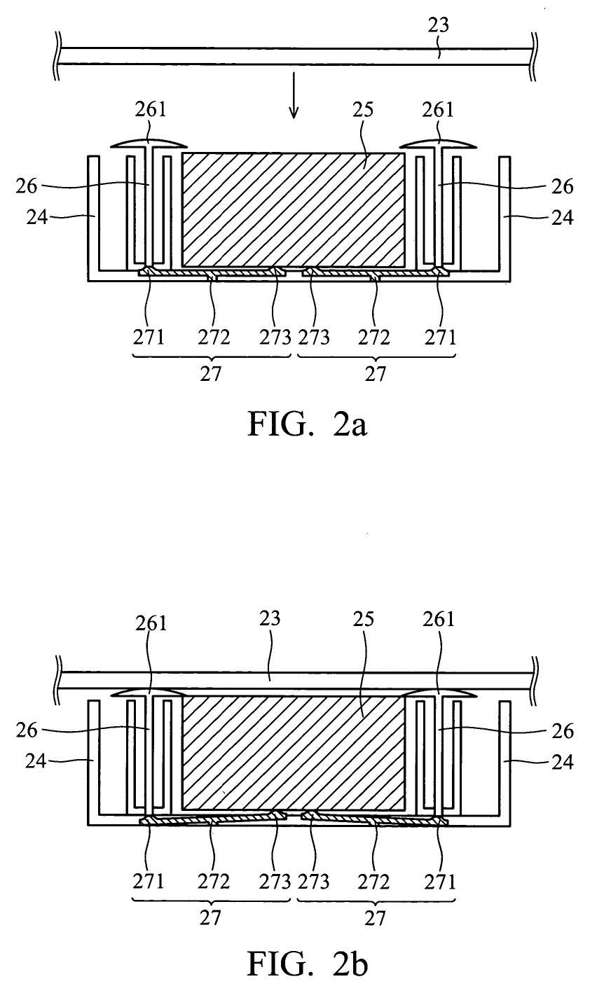

FIGS. 2a and 2b show a scanner of the present invention. Devices and elements common with a conventional scanner are omitted. FIG. 2a shows a cross section of the scanner before a platen is attached thereon and FIG. 2b shows after the platen is attached thereon. The scanner of the present invention comprises a platen 23, a scanning device and a supporting structure. In this embodiment, the scanning device comprises a carriage 24 and a sensor 25. The sensor can be a contact image sensor (CIS). The supporting structure comprises a contacting member 26 and a resilient member 27.

An object such as a document or picture is placed on the platen 23. The carriage 24 is disposed under the platen 23 and the sensor 25 is received therein. The sensor 25 scans the object via the platen 23. The contacting member 26 is disposed in the carriage 24, having a rounded top 261. The contacting member 26 contacts the platen 23 via the rounded top 261. The resilient member 27 is disposed under the contacting member 26, having a first portion 271, a second portion 272 and a third portion 273. The first portion 271 connects or contacts an end of the contacting member 26 opposite to the rounded top 261. The second portion 272 pivots with the carriage 24. The third portion 273 connects or contacts the sensor 25, adhered thereto, such as by adhesive.

In FIG. 2a, the sensor 25 and the contacting member 26 are disposed in the carriage 24 but not the platen 23 such that the resilient member 27 does not deform. The rounded top 261 of the contacting member 26 is higher than the final assembled position of the platen 23. Therefore, when the platen 23 is installed on the scanner, the platen 23 pushes the contacting member 26 toward the first portion 271.

FIG. 2b shows the platen 23 installed on the scanner. The platen 23 pushes the contacting member 26 to move the first portion 271 downward, rotating the resilient member 27 via the second portion 272, such that the third portion 273 supports and moves the sensor 25 upward to maintain a predetermined distance between the sensor 25 and the platen 23. In this embodiment, after being raised, the sensor 25 contacts the lower surface of rounded top 261. Namely, the resilient member 27 deforms due to the platen 23 moving downward, maintaining the predetermined distance between the sensor 25 and the platen 23 via the contacting member 26, thereby maintaining the object focus of the sensor 25 to ensure optical quality. A driving mechanism (not shown) continues to convey the carriage 24, completing the scanning process.

Furthermore, the resilient member and the carriage can be integrally formed or the resilient member can be separably disposed on the carriage. When the resilient member and the carriage are integrally formed, the resilient member is formed at the bottom of the carriage, pivoting such that one end connects to or contacts the contacting member, and the other end the sensor. The pivot of the seesaw is integrally formed on the carriage.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A scanner, comprising:
a platen;
a scanning device movably disposed under the platen;
a supporting structure disposed in the scanning device, comprising a contacting member and a resilient member connected to the contacting member, wherein when the platen abuts the contacting member, the resilient member deforms to move the scanning device to contact the contacting member, and a predetermined distance is maintained between the platen and the scanning device.

2. The scanner as claimed in claim 1, wherein the scanning device and the resilient member are integrally formed.

3. The scanner as claimed in claim 1, wherein the resilient member comprises a first portion supporting the contacting member, a second portion disposed on the scanning device and a third portion supporting the scanning device, such that when the platen abuts the contacting member to move the first portion, the resilient member rotates via the second portion, and the third portion moves toward the scanning device until the scanning device contacts the contacting member.

4. The scanner as claimed in claim 1, wherein the scanning device comprises a sensor and a carriage receiving the sensor.

5. The scanner as claimed in claim 4, wherein the resilient member comprises a first portion supporting the contacting member, a second portion disposed on the carriage and a third portion supporting the sensor, wherein when the platen abuts the contacting member to move the first portion, the resilient member rotates via the second portion, and the third portion moves toward the sensor until the sensor contacts the contacting member.

6. The scanner as claimed in claim 4, wherein the carriage and the resilient member are integrally formed.

7. The scanner as claimed in claim 4, wherein the sensor is a contact image sensor (CIS)

8. The scanner as claimed in claim 1, further comprising a driving mechanism contacting and conveying the scanning device.
